(19) United States
(12) Patent Application Publication
(10) Pub. No.: US 2015/0002273 A1
(43) Pub. Date: Jan. 1, 2015

(54) RFID TAG BLOCKING

(71) Applicant: HAND HELD PRODUCTS, INC., Fort Mill, SC (US)

(72) Inventors: Edward C. BREMER, Victor, NY (US); Stephen Patrick DELOGE, Palmyra, NY (US)

(73) Assignee: HAND HELD PRODUCTS, INC., Fort Mill, SC (US)

(21) Appl. No.: 13/960,449

(22) Filed: Aug. 6, 2013

Related U.S. Application Data
(60) Provisional application No. 61/840,858, filed on Jun. 28, 2013.

(51) Int. Cl. G06K 7/10

(52) U.S. Cl. CPC G06K 7/10287
USPC 340/10.5

(57) ABSTRACT

Methods and systems of blocking transponder signals is provided. A jamming signal received from at least one jamming transponder, where the at least one jamming transponder may be located in an area proximate to a transmitting transponder. An RFID reader is unable to read data contained in the transponder signal in response to receiving the jamming signal.

### CROSS-REFERENCE TO RELATED APPLICATION

This application claims the benefit of priority to co-pending U.S. Provisional Patent Application No. 61/840,858, filed on Jun. 28, 2013, which is hereby incorporated by reference in its entirety.

### BACKGROUND

Systems which employ radio frequency identification (RFID) technology are currently used to recognize and/or to identify all types of objects bearing an adapted RFID tag. In this regard, an RFID reader may be placed in an area which has several RFID tags and would read all of the RFID tags whose range extends to the RFID reader even if some of the RFID tags may not be desired to be read. For example, if it is desired for a RFID reader to read only RFID tags in a shopping cart, the RFID reader may still read RFID tags in another shopping cart due to the proximity thereof. In this regard, issues are created when an RFID reader reads undesired RFID tags.

### SUMMARY

To address the above issues, an RFID system is provided to restrict the RFID tags that can be read by the RFID tag reader. An RFID tag reader may be constructed to transmit a high signal level at the frequencies that RFID tags transmit their data. By overwhelming the channels at which the RFID tags communicate, the RFID tags can be prevented from being read by other RFID tag readers. By arranging the RFID tag jammers in an area, different zones of jamming and non jamming can be established.

In one embodiment, a method of blocking transponder signals is provided. A transponder signal is received from a transmitting transponder, where the transponder signal may contain data identifying an associated item. A jamming signal is received from at least one jamming transponder, where the at least one jamming transponder may be located in an area proximate to the transmitting transponder. An RFID reader is unable to read data contained in the transponder signal in response to simultaneously receiving a combination of the jamming signal and the transponder signal.

In another embodiment, an RFID system for blocking transponder signals may include at least one transmitting transponder configured to output a transponder signal; at least one jamming transponder placed proximate to the at least one transmitting transponder and configured to output a jamming signal; and an RFID reader configured to receive the transponder signal and the jamming signal so that when the RFID reader receives a combination of the transponder signal and the jamming signal the RFID is unable to read data from the transponder signal.

In yet another embodiment, a method of blocking transponder signals may include repeatedly transmitting a first interrogation signal from a jamming transponder to a transmitting transponder so that the transmitting transponder is repeatedly energized and repeated responds to the first interrogation signal. In this regard, if a second interrogation signal is sent from an RFID reader to the transmitting transponder while the jamming transponder repeatedly transmits the first interrogation signal to the transmitting transponder, the repeated transmission of the first interrogation signal prevents the transmitting transponder to respond to the second interrogation signal.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of embodiments of the invention. In the drawings, like numerals are used to indicate like parts throughout the various views.

FIGS. 1A-1C schematically illustrate one embodiment of an RFID reader according to an embodiment;

FIG. 2 depicts a network-level layout of a data collection system utilizing RFID readers according to an embodiment;

FIG. 3 depicts component-level layout of an RFID reader;

FIG. 4 is a system diagram of an RFID system having jamming zones and non jamming zones according to an embodiment.

FIG. 5 is another system diagram of an RFID system having jamming zones and non jamming zones according to another embodiment.

FIG. 6 illustrates a method of blocking transponders in a jamming zone according to some embodiments.

### DETAILED DESCRIPTION OF THE EMBODIMENTS

Various examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

Examples of the invention include various methods and apparatuses for defining areas where RFID tags are jammed and other areas where RFID tags are not jammed. This allows RFID tags to only be read by RFID tag readers in certain areas.

Various embodiments of the present invention use an RFID reader. The RFID reader can be used in a numerous applications, including but not limited to, authentication and access control systems (for example, using smart cards), item tracking in manufacturing and retail, etc. A smart card is an identification card (e.g., a credit card, a pass card) which does not need to be swiped or otherwise physically contacted by a card reader. This capability can be implemented by placing an RFID tag in the card. Item tracking can be implemented by placing an RFID tag on each individual item. In retail, item tracking with RFID tags can be used in conjunction with other technologies such as bar code scanning and payment terminals. Item tracking with RFID tags can be used in loss prevention systems by placing an RFID tag into merchandise items and placing sensors at exit points. If an exit sensor detects a tagged item with a tag, which was not deactivated at the checkout, an alarm can go off.

There may be situations where an administrator would like to define an RFID jamming zone which may be an area where transponders, such as RFID tags, in such jamming zone cannot be read. For example, a merchandising store may want to establish RFID jamming zones within the store after the store closes so that potential thieves cannot read transponders on merchandise. As another example, a merchandising store may set up jamming zones outside of the store so that RFID readers being deployed outside of the store cannot read any transponders within the store. There are numerous other applications of establishing jamming zones, and the above-described embodiments are only exemplary applications.

The system, according to one embodiment, includes one or more jamming transponders and one or more transmitting transponders. The jamming transponders form one or more jamming zones where at least one of the transmitting transponders may be located in the jamming zone. An RFID reader in the jamming zone may be unable to read the transmitting transponders while the RFID reader is in the jamming zone.

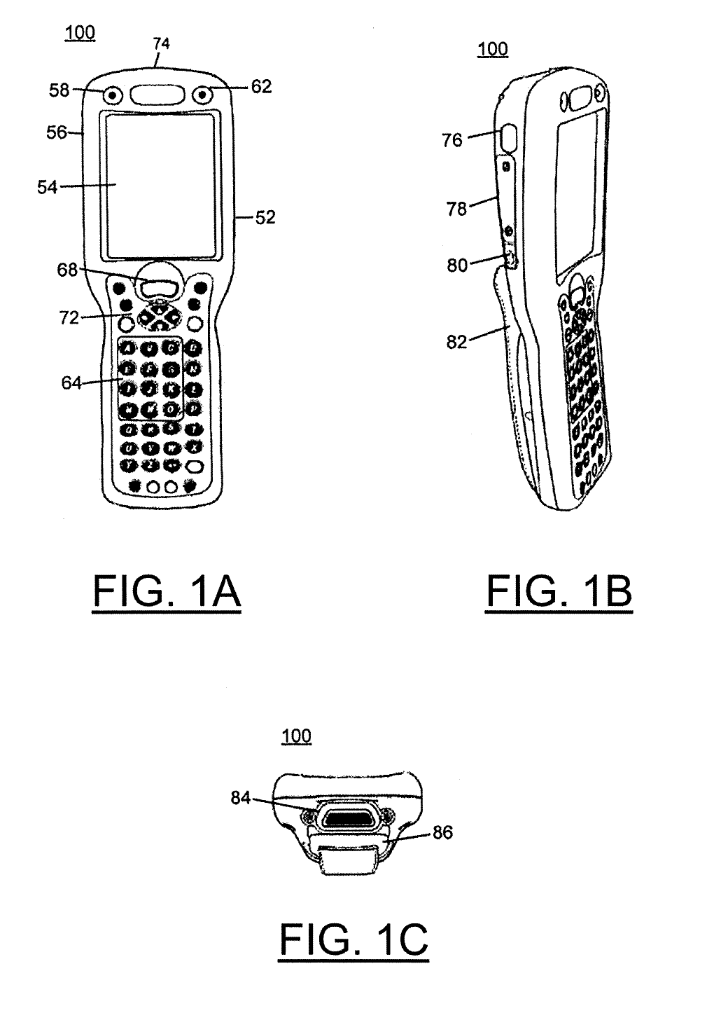

An RFID reader 100 is shown in FIGS. 1A (front panel view), 1B (side panel view), and 1C (bottom panel view). RFID reader 100 can comprise housing 52 within which other components of RFID reader 100 can be disposed. LCD screen display with touch screen sensor 54 can be disposed on the front panel 56. Also disposed on front panel 56 can be decode LED 58, scan led 62, and keyboard 64 including scan key 68 and navigation keys 72. Imaging window 74 can be disposed on the top panel of housing 52. Disposed on the side panel (best viewed in FIG. 1B) can be infra-red communication port 76, access door to a secure digital (SD) memory interface 78, audio jack 80, and hand strap 82. Disposed on the bottom panel (best viewed in FIG. 1C) can be multi-pin mechanical connector 84 and hand strap clip 86.

While FIGS. 1A-1C illustrate a hand held housing, a skilled artisan would appreciate the fact that other types and form factors of terminal housings are within the scope of this disclosure. Thus, the present disclosure should not be limited to hand held devices.

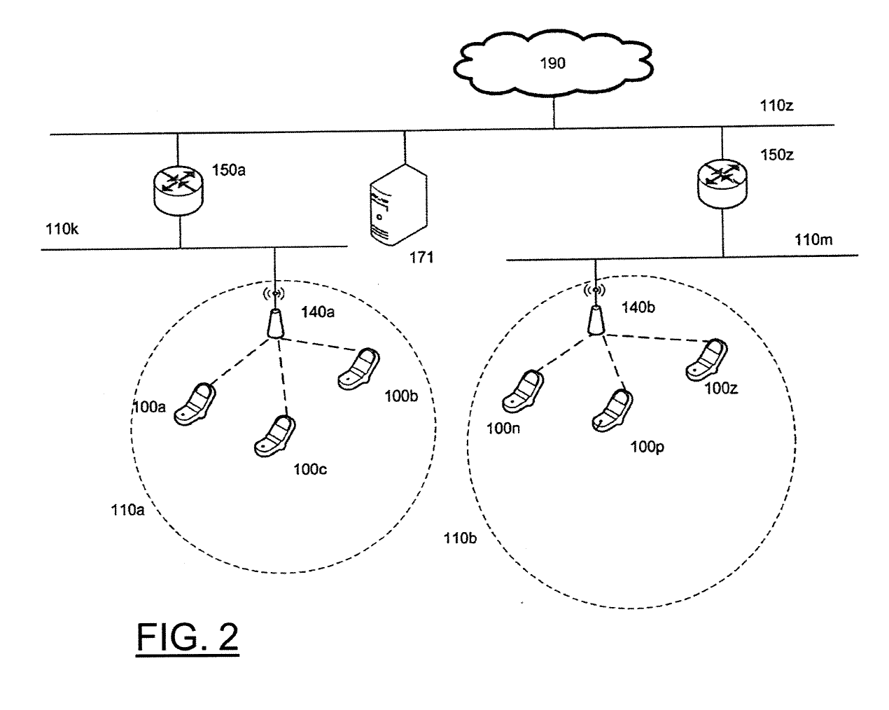

In a further aspect, the RFID reader can be incorporated in a data collection system. The data collection system, schematically shown in FIG. 2, can include a plurality of RFID readers 100a-100z in communication with a plurality of interconnected networks 110a-110z. In one aspect, the plurality of networks 110a-110z can include at least one wireless communication network. In a further aspect, an RFID reader can comprise a communication interface which can be used by the terminal to connect to one or more networks 110a-110z. In one embodiment, the communication interface can be provided by a wireless communication interface.

The RFID reader 100c can establish a communication session with the host computer 171. In one embodiment, network frames can be exchanged by the RFID reader 100c and the host computer 171 via one or more routers, base stations, and other infrastructure elements. In another embodiment, the host computer 171 can be reachable by the RFID reader 100c via a local area network (LAN). In a yet another embodiment, the host computer 171 can be reachable by the RFID reader 100c via a wide area network (WAN). A skilled artisan would appreciate the fact that other methods of providing interconnectivity between the RFID reader 100c and the host computer 171 relying upon LANs, WANs, virtual private networks (VPNs), and/or other types of network are within the scope of this disclosure.

In one embodiment, the communications between the RFID reader 100c and the host computer 171 can comprise a series of HTTP requests and responses transmitted over one or more TCP connections. In one embodiment, the communications between the RFID reader 100c and the host computer 171 can comprise VoIP traffic transmitted over one or more TCP and/or UDP ports. A skilled artisan would appreciate the fact that using other transport and application level protocols is within the scope and the spirit of the invention.

In one aspect, at least one of the messages transmitted by the RFID reader can include decoded message data corresponding to, e.g., an RFID tag attached to a product or to a shipment item. For example, an RFID reader can transmit a request to the host computer to retrieve product information corresponding to a product identifier encoded by a RFID tag.

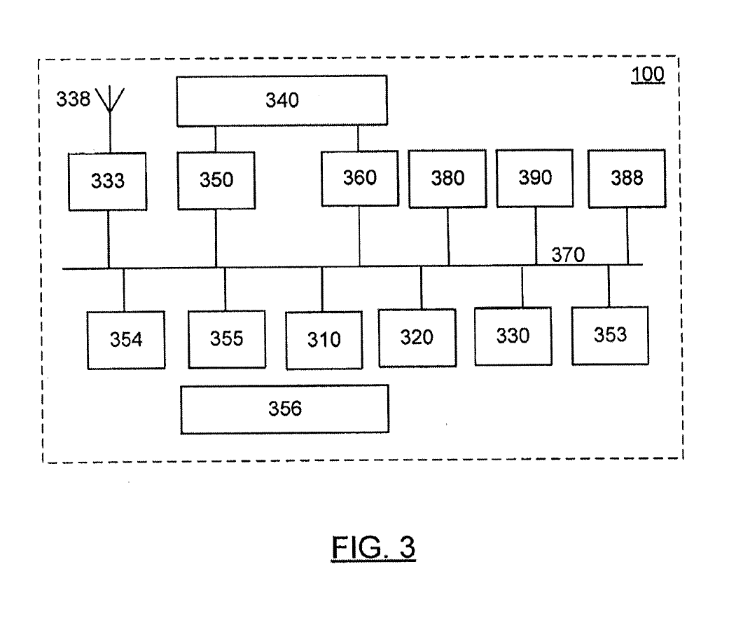

Component-level diagram of one embodiment of an RFID reader is now being described with references to FIG. 3. RFID reader 100 can comprise at least one microprocessor 310 and a memory 320, both coupled to the system bus 370. The microprocessor 310 can be provided by a general purpose microprocessor or by a specialized microprocessor (e.g., an ASIC). In one embodiment, RFID reader 100 can comprise a single microprocessor which can be referred to as a central processing unit (CPU). In another embodiment, RFID reader 100 can comprise two or more microprocessors, for example, a CPU providing some or most of the RFID reader functionality and a specialized microprocessor performing some specific functionality. A skilled artisan would appreciate the fact that other schemes of processing tasks distribution among two or more microprocessors are within the scope of this disclosure.

RFID reader 100 can further comprise a communication interface 340 communicatively coupled to the system bus 370. In one embodiment, the communication interface can be provided by a wireless communication interface. The wireless communication interface can be configured to support, for example, but not limited to, the following protocols: at least one protocol of the IEEE 802.11/802.15/802.16 protocol family, at least one protocol of the HSPA/GSM/GPRS/EDGE protocol family, TDMA protocol, UMTS protocol, LTE protocol, and/or at least one protocol of the CDMA/IxEV-DO protocol family.

RFID reader 100 can further comprise a keyboard interface 354 and a display adapter 355, both also coupled to the system bus 370. RFID reader 100 can further comprise a battery 356. In one embodiment, the battery 356 can be provided by a replaceable rechargeable battery pack.

RFID reader 100 can further comprise a GPS receiver 380. RFID reader 100 can further comprise at least one connector 390 configured to receive a subscriber identity module (SIM) card.

RFID reader 100 can further comprise one or more devices 330, provided, for example, but not limited to, by an RFID reading device, a bar code reading device, or a card reading device. In one embodiment, the RFID terminal can be configured to read an encoded message using reading device 330, and to output raw message data containing the encoded message. In another embodiment, the RFID terminal can be configured to read an encoded message using reading device 330, and to output decoded message data corresponding to the encoded message. As used herein, “message” is intended to denote a character string comprising alphanumeric and/or non-alphanumeric characters. An encoded message can be used to convey information, such as identification of the source and the model of a product, for example, in a UPC code.

Of course, devices that read bar codes, read RFID, and/or read cards bearing encoded information may read more than one of these categories while remaining within the scope of this disclosure. For example, a device that reads bar codes may include a card reader, and/or RFID reader; a device that reads RFID may also be able to read bar codes and/or cards; and a device that reads cards may be able to also read bar codes and/or RFID. For further clarity, it is not necessary that a device's primary function involve any of these functions in order to be considered such a device; for example, a cellular telephone, smartphone, or PDA that is capable of reading bar codes is a device that read bar codes for purposes of this disclosure.

As noted herein supra, in one embodiment, RFID reader 100 can further comprise an RFID reading device 333. RFID reader 100 can be configured to read RFID tags containing decoded messages. In one embodiment, the RFID terminal can be configured to read, using RFID reading device 333, an RFID tag containing an encoded message, and to output raw message data containing the encoded message. In another embodiment, the RFID terminal can be configured to read, using RFID reading device 333, an RFID tag containing an encoded message, and to output decoded message data corresponding to the encoded message.

In a further aspect, the RFID reading device can comprise an antenna 338 to receive the encoded message from one or more transponders.

While FIG. 3 describes some embodiments of a RFID reader, it should be understood that the present disclosure need not be limited to such RFID reader and, thus, could be implemented into various other RFID readers.

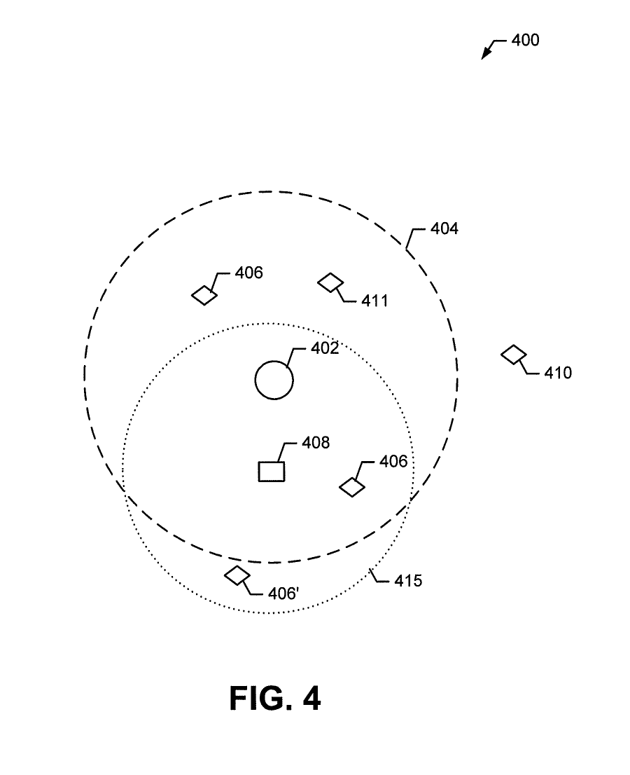

FIG. 4 illustrates a system 400 of RFID blocking using a jamming zone 404 according to one embodiment. In one aspect, the jamming zone includes at least one jamming transponder 402, as previously mentioned. The jamming transponder may be a specifically-designed transponder which is configured such that when an RFID reader 408 is placed within a zone about the jamming transponder (e.g., the jamming zone), data from transmitting transponders 406 that are within the RFID reader area 415 (and/or are within the jamming zone 404) cannot be read by the RFID reader 408. In one embodiment, the jamming transponder may actually jam a signal sent by transmitting transponders to an RFID reader. In another embodiment, the jamming transponder prevents the transmitting transponders from sending any signal to RFID readers. Each of these embodiments is discussed in more depth below.

For example, for jamming zone 404 for FIG. 4, the jamming transponder 402 may be configured to transmit a signal at the same frequency as the transponders 406. In this regard, an RFID reader 408 that is within the jamming zone 404 receives signals from both the jamming transponder 402 and the transmitting transponder 406, resulting in a combination signal that includes a superimposed signal from the transmitting transponder 406, 406 and the signal from the jamming transponder 402. The combination signal results in data from the transmitting transponder 406 combined with data from the jamming transponder 402. The resulting combined data is not recognized by the RFID reader 408 and thus, the signal from the transmitting transponder 406 (which is in the combined data signal) is prevented from being read and properly processed by the RFID reader 408.

With regard to transmitting transponder 406′, this transponder is located outside of the jamming zone 404 but within the reach of the RFID reader's range 415. However, the RFID reader 408 may also prevented from reading transmitting transponder 406′ because the jamming signal from jamming transponder 402 may combine with the signal from transmitting transponder 406′ prior to reaching RFID reader 408. In this regard, only the combination signal is received by the RFID reader 408 even though transmitting transponder 406′ is located outside of the jamming zone 404 as long as the RFID reader is within the jamming zone 404.

Additionally, it should be noted that neither transmitting transponder 410 nor transmitting transponder 412 are within both the range of the jamming zone 404 and the range 415 of RFID reader 408. For example, transmitting transponder 410 and transmitting transponder 411 are not in RFID reader range 415. As such, even though the RFID reader is within the jamming zone, the RFID reader will not read the signals from these transponders. However, transponder 406′ is within the range 415 of the RFID reader but outside of the jamming zone 404. Thus, in one embodiment, the jamming transponder 402 only prevents RFID reader 408 from reading a transmitting transponder if such transmitting transponder is within the range 415 of the RFID reader 408 while the RFID reader is within the range 404 of the jamming transponder 402.

In one embodiment, the jamming transponder 402 may have a signal strength which is much greater than the transmitting transponder 406 in jamming zone 404. In this regard, the RFID reader 408 receives a combination signal including a signal from the transmitting transponder 406 and the jamming transponder 402. Such combination signal, in this embodiment, includes both the transmitting transponder signal (transmitted from the transmitting transponder 406) that has a first signal strength and the jamming transponder signal (transmitted from the jamming transponder 402) that has a second signal strength, where the second signal strength is at least a factor (e.g., 2×-100×) greater than the first signal strength so that the combination of the transmitting transponder signal and jamming transponder signal is prevented from being read by the RFID reader 408. The signal strengths of the combination of these signals may be cumulative in that the signal strengths of the transmitting transponder signal and the jamming transponder signal add to each other resulting in an overall combined signal strength. For example, the first signal strength from the transmitting transponder 406 may be at a level of 5 and the second signal strength from the jamming transponder 402 may be at 100 so that the superimposed combination signal strength is 105. The RFID reader 408 reads the combination signal as a single signal having a signal strength of 105 and, as such, the transmitting transponder signal appears to the RFID reader 408 as noise (since such transmitting transponder signal is relatively small compared with the combined signal) and as such is not read and processed by the RFID reader 408.

In another aspect, the jamming transponder may perform a combination of the above-described techniques. In this regard, the jamming transponder 402 may transmit both (1) a high signal strength level relative to the signal strength levels from the transmitting transponders 406 in the jamming zone 404, and (2) at the frequencies that the transmitting transponders 406 (in the jamming zone 404) transmit their data. By overwhelming the channels at which the transmitting RFID tags communicate in the jamming zone, the transmitting transponders 406 (e.g., the RFID tags) in the jamming zone 404 can be prevented from being read by other RFID readers.

It should be understood that the range of the jamming transponders may be significantly greater than the transmitting transponders so as to cover the coverage area of the transmitting transponders, especially if the transmitting transponders are spaced apart so that the jamming transponders may not be adjacent to each transmitting transponder.

In one embodiment, while the RFID reader is within the jamming zone 404 (e.g., the RFID reader is within the area 404 defined by the transmission range of the jamming transponder), the RFID reader 408 is prevented from reading transmitting transponders 406 which are in the range 415 of the RFID reader 408, regardless if the transmitting transponders 406 are outside of the jamming range 404 of the jamming transponder 402. This may be because the jamming transponder 402 may only need to be proximate to the RFID reader, in one embodiment, so that any signal that reaches the RFID reader in the jamming zone is combined with the jamming transponder signal prior to reaching the RFID reader. As such, the combined signal, as described above, would prevent the RFID reader from discerning (and thus, reading) the transmitting transponder signal from the combined signal.

In another embodiment, a jamming transponder may keep transmitting transponders occupied so that RFID readers cannot read the transmitting transponder. A transmitting transponder may operate as an active or passive transponder. Active transponders have an on-board battery while passive transponders do not. For passive transponders, an RFID reader (or other source) energizes the transponder by sending an interrogation signal to the transponder. In response thereto, the transponder uses the power received from the RFID reader interrogation signal to transmit a signal back to the RFID reader. If the transponder is already energized by the RFID reader (or other source), the transmitting transponder does not transmit a response signal to another RFID reader which is attempting to interrogate the occupied transponder. As such, a jamming transponder may continually send interrogation signals to the transmitting transponder to emulate an RFID reader so that if an RFID reader sends its own interrogation signal to the transmitting transponder, the transmitting transponder does not send a response signal back to the RFID reader. As such, the jamming transponder can effectively prevent transmitting transponders in a jamming area from transmitting response signals back to RFID readers attempting to read the transmitting transponders. In this regard and referring to FIG. 4, the jamming transponder 402 could keep transponders 406 and 411 occupied by continuously sending interrogation signals thereto, but would not keep transponders 406′ and 410 occupied since these transponders are outside of the jamming transponder's range 404. Thus, the RFID reader 408, in this example, could read only transponder 406′. RFID reader 408 would also be able to read transponder 410 when such transponder enters the range 415 of the RFID reader 408.

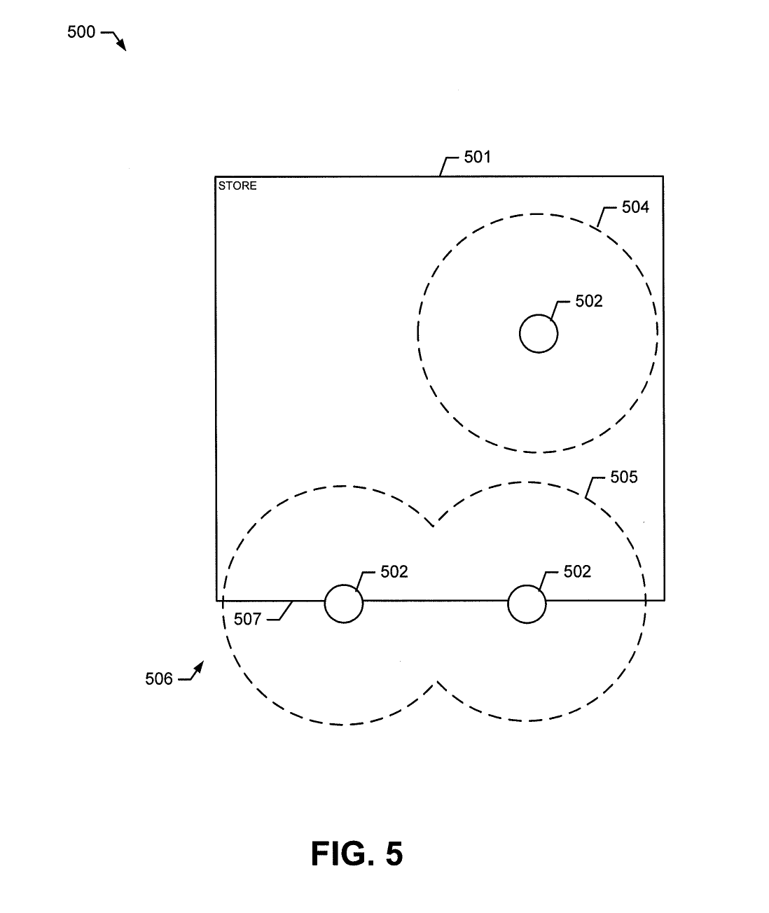

As illustrated in FIG. 5, a user may establish be multiple jamming zones 504, 505. Each jamming zone may be defined by a radius about each respective jamming transponder. If the user wishes to increase the size of the jamming zone (such as if the user wishes a jamming zone that is larger than a single jamming transponder would create), the user could place multiple jamming transponders so that the ranges overlap to create a combined jamming zone 505 which is greater than a single jamming zone 504. For example, in FIG. 5, a store 501 may wish to create a jamming zone at the front 506 of the store so that and RFID readers which may scan for transponders in the building would be blocked from doing so. In this regard, the jamming transponders would be placed at the front wall 507 of the store 501 so that the range 505 of the transponders 502 would extend to any RFID readers outside of the store. It should be noted that there are non-jamming areas which would allow for an RFID reader (not shown) to read transmitting transponders which are not in the jamming zones 504, 505. However, when the RFID reader enters the jamming zones, the RFID reader may then be prevented (using one or more of the above techniques) the transmitting transponders. Therefore, in light of the above, the user could create jamming zone(s) and non jamming zones based on the arrangement of jamming transponders.

It should be noted that, in one embodiment, the jamming transponders may have a range which is significantly greater than the range of each individual transmitting transponder. In that way, the transmitting transponders would not transmit outside of the jamming transponder range.

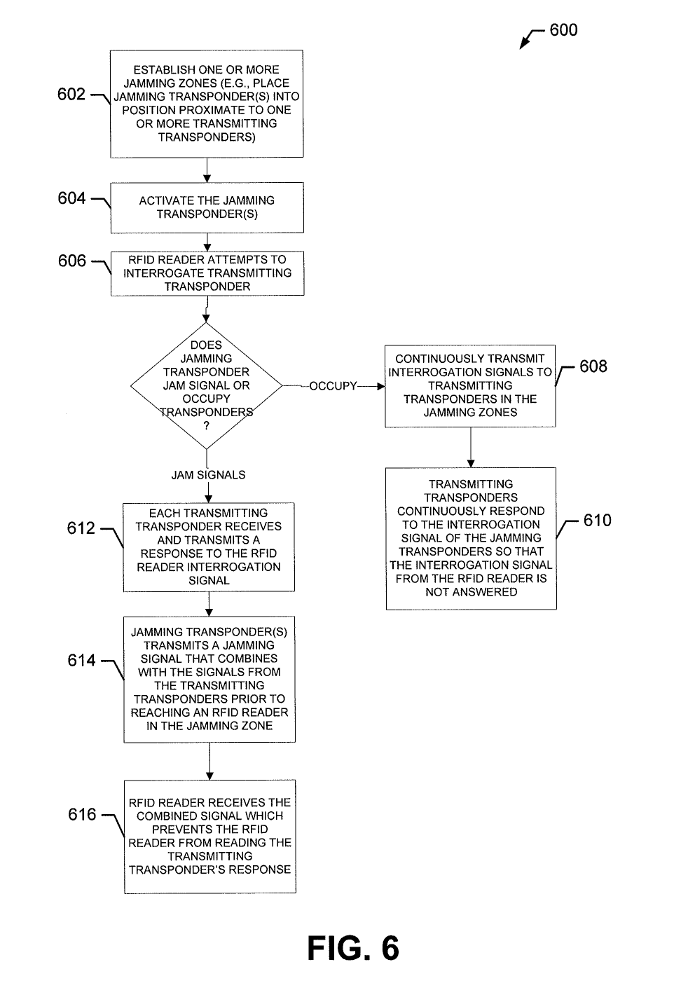

FIG. 6 illustrates a method 600 of RFID tag blocking according to one embodiment. In block 602, one or more jamming zones are established. This may be accomplished by placing one or more jamming transponders proximate to one or more transmitting transponders desired to be blocked and/or proximate to a location where an RFID reader is desired to be prevented from reading transmitting transponders.

In block 604, the jamming transponders are activated to prevent one or more RFID readers from reading transmitting transponders in the jamming zone. As previously discussed, the transmitting transponders may be prevented from being read by the jamming transponder transmitting a signal at the same frequencies as the transmitting transponders' signals, at a signal level that is significantly greater than the transmitting transponders signals, and/or a combination thereof. The jamming transponders may also (or alternatively) continually occupy the transmitting transponders in the jamming zones by continuously transmitting interrogation signals, as described above.

In block 606, an RFID reader in the jamming zone (and/or receiving signals from a transmitting transponder in the jamming zone) attempts to interrogate a transmitting transponder. In this regard, the RFID reader transmits an interrogation signal to transponders within a proximity of the RFID reader.

In block 608, if the jamming transponder is configured to occupy the transmitting transponders, the jamming transponder continuously sends interrogation signals to transmitting transponders within the jamming zone so that if the transmitting transponders receive an interrogation signal from an RFID reader, the transmitting transponders will not respond thereto.

At block 610, the transmitting transponders continuously respond to the interrogation signal of the jamming transponder. As previously discussed, because the transmitting transponders are occupied responding to the jamming transponder, the transmitting transponders do not answer or respond to the interrogation signal from an RFID reader. In this regard, the transmitting transponders are not read by an RFID reader while being occupied by the jamming transponder.

If the jamming transponder is configured to combine (and therefore jam) signals with the transmitting transponders' signals, the method 600 proceeds to block 612 (from block 606). In block 612, the transmitting transponders that receive the interrogation signal from the RFID reader transmit a response to the RFID reader. Such response may be in the form of a signal back to the RFID reader at a specific frequency/channel and may have a predetermined signal level.

At block 614, prior to the transmitting transponder's signal reaching the RFID reader, the jamming transponder transmits a signal having a high signal strength and/or having a frequency at the same frequency as the transmitting transponder. The jamming transponder's signal combines with the transmitting transponders' signals prior to (or at the same that as) being received by the RFID reader transceiver so that the RFID reader only receives the combination signal, as discussed above. The jamming transponder may continuously send out such jamming signal or may only send out such jamming signal in response to receiving an interrogation signal from an RFID reader.

In block 616, the RFID reader receives the combination signal (i.e., the transmitting transponder signal combined with the jamming transponder signal) so that the RFID reader is prevented from deciphering the transmitting transponder's signal and is prevented from receiving the transponders signal separate from the combination signal. The RFID reader then would ignore the data received from the combination signal. In this regard, the signal sent from the transmitting transponder (which is only received at the RFID reader in the combination signal) is effectively blocked from being read and processed by the RFID reader.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention may be recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C.§112, 6 will begin with the words “means for”.) Accordingly, the inventors reserve the right to add additional claims after filing the application to pursue such additional claim forms for other aspects of the invention.

What is claimed is:

1. A method for blocking transponder signals, the method comprising:
receiving a transponder signal from a transmitting transponder, the transponder signal containing data;
receiving a jamming signal from at least one jamming transponder, wherein the at least one jamming transponder is located in an area proximate to the transmitting transponder; and
preventing reading of the data contained in the transponder signal in response to simultaneously receiving the jamming signal and the transponder signal.

2. The method of claim 1, wherein the transmitting transponder comprises a first radio frequency identification (“RFID”) tag and the at least one blocking transponder comprises a second RFID tag.

3. The method of claim 1, further comprising placing the at least one jamming transponder in the area proximate to the transmitting transponder so that when an RFID reader receives the transponder signal the RFID also simultaneously receives the jamming signal.

4. The method of claim 1, wherein a first signal strength of the jamming signal of the at least one jamming transponder is greater than a second signal strength of the transponder signal of the transmitting transponder so that an RFID reader is unable to identify data in the transponder signal.

5. The method of claim 1, wherein first data of the jamming signal is such that when combined with second data of the transmitting transponder the RFID reader is unable to identify the first data so that the first data is properly processed.

6. The method of claim 1, wherein the blocking transponder is located in a first zone that is separate from a second zone so that data received by an RFID reader from transmitting transponders located in the first zone is not read but data from transmitting transponders located in a second zone may be read by an RFID reader.

7. The method of claim 1, wherein the jamming signal and transponder signal transmit data at the same frequency.

8. The method of claim 1, wherein the data of the transponder signal is associated with an item upon which the transmitting transponder is attached, and wherein simultaneous receipt of the jamming signal and the transponder signal prevents identifying the item.

9. A radio frequency identification (“RFID”) system comprising:
an RFID interrogator antenna; and
a processor configured to receive signals from the RFID antenna, wherein the processor is configured to:
receive a transponder signal from a transmitting transponder, the transponder signal containing data identifying an associated item;
receive a jamming signal from at least one blocking transponder, wherein the at least one blocking transponder is located in an area proximate to the transmitting transponder; and
preventing processing of data contained in the transponder signal in response to receiving a combination of the jamming signal and the transponder signal.

10. The radio frequency identification system of claim 9, wherein the transmitting transponder comprises a first radio frequency identification (“RFID”) tag and the at least one blocking transponder comprises a second RFID tag.

11. The radio frequency identification system of claim 9, wherein a first signal strength of the jamming signal of the blocking transponder is greater than a second signal strength of the transponder signal of the transmitting transponder so that an RFID reader is unable to identify data in the transponder signal.

12. The radio frequency identification system of claim 9, wherein first data of the jamming signal is such that when combined with second data of the transmitting transponder the RFID reader is unable to identify the first data so that the first data is properly processed.

13. A radio frequency identification (“RFID”) system for blocking transponder signals, the RFID system comprising:
at least one transmitting transponder configured to output a transponder signal;
at least one jamming transponder placed proximate to the at least one transmitting transponder and configured to output a jamming signal; and
an RFID reader configured to receive the transponder signal and the jamming signal so that when the RFID reader receives a combination of the transponder signal and the jamming signal the RFID is unable to read data from the transponder signal.

14. The radio frequency identification system of claim 13, wherein the at least one transmitting transponder comprises a first radio frequency identification tag and the at least one jamming transponder comprises a second RFID tag.

15. The radio frequency identification system of claim 13, wherein a first signal strength of the jamming signal of the at least one jamming transponder is greater than a second signal strength of the transponder signal of the transmitting transponder so that an RFID reader is unable to read data in the transponder signal.

16. The radio frequency identification system of claim 15, wherein the jamming signal and the transponder signal transmit data at the same frequency.

17. The radio frequency identification system of claim 13, wherein first data of the jamming signal is such that when combined with second data of the transmitting transponder the RFID reader is unable to read the first data.

18. A method of blocking transponder signals, the method comprising:
repeatedly transmitting a first interrogation signal from a jamming transponder to a transmitting transponder so that the transmitting transponder is repeatedly energized and repeated responds to the first interrogation signal;
wherein in response to a second interrogation signal sent from an RFID reader to the transmitting transponder while the jamming transponder repeatedly transmits the first interrogation signal to the transmitting transponder, the repeated transmission of the first interrogation signal prevents the transmitting transponder from responding to the second interrogation signal.

19. The method of claim 18, wherein the jamming transponder transmits the first interrogation signal in an area that also encompasses the transmitting transponder and the RFID reader.

20. The method of claim 18, wherein the response to the first interrogation signal is unable to be read by the RFID reader.
